(19) United States
(12) Patent Application Publication
(10) Pub. No.: US 2002/0066157 A1
(43) Pub. Date: Jun. 6, 2002

(54) Door closer

(76) Inventor: Sha-Na Chen, Chang Hua Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/729,793

(22) Filed: Dec. 6, 2000

(51) Int. Cl. E05F 3/14; E05F 3/22

(52) U.S. Cl. 16/58

(57) ABSTRACT

An improved door closer includes a base fixedly provided on an inner side of a door, and a link member. The inner side of the base is provided with a piston. The piston is biased by a release member, and has a connecting block and left and right end blocks extending upward from two ends of the connecting block. The bottom portion of the connecting block is provided with a guide groove in the same direction as a long axis of the base. The right end block is recessed inward to form an insert groove. A roller is pivoted in the insert groove. A transmission shaft passes through the guide groove of the piston. The intermediate portion of the transmission shaft is provided with a cam abutting against the roller. When an external force pushes open the door, the cam is rotated to cause the piston to bring the release member into a compressed state. When the external force is released, the force released by the release member when it resumes its original shape causes the piston to push the cam to rotate, thereby closing the door.

### BACKGROUND OF THE INVENTION

(a) Field of the Invention

The present invention relates to a door closing device, more particularly to an improved door closer.

(b) Description of the Prior Art

Generally, the prior door closer is an assembly of gear, rack, piston, action shaft and spring is used to achieve door closing. A hydraulic oil system is employed to adjust speed of operation of the door closer. However, since there are tooth clearances in the gear and rack arrangement, improper configuration of the size of the clearance may affect the rack and gear during operation. In other words, intermittent contact between the rack and the gear may result from wear, which affects smooth operation. In addition, since said product teaches a single-direction operation, the door can be opened in a specific direction only.

### SUMMARY OF THE INVENTION

The primary object of the present invention is to provide an improved door closer, which does not need to take into consideration existence of tooth clearance, and which can make door opening and closing operations smooth.

Another object of the present invention is to provide an improved door closer, which enables the user to open the door from different directions and thus provides preferred user facility.

In order to achieve the above-mentioned objects, the improved door closer of this invention includes a base which is axially provided with a transverse channel; a piston slidable in the channel and having a connecting block and left and right end blocks extending upwardly from two ends of the connecting block, the connecting block having a bottom portion provided with a guide groove in the same direction as a long axis direction of the base, the right end block being recessed inwardly to form an insert groove, the right end block being provided with an axial hole relative to upper and lower ends of the insert groove, a roller being pivotally disposed in the insert groove; a release member disposed in the channel to permit reciprocating movement of the piston therein; a transmission shaft passing through the guide groove of the piston, an intermediate portion of the transmission shaft having a cam projecting therefrom to abut against the roller; and a link member having one end connecting to a top end of the transmission shaft, with the other end pivoted at an upper edge of a door frame. When the door is pushed open by an external force, the cam rotates to cause the release member to be in a compressed state, and when the external force is released, a pushing force released by the release member when the release member resumes its original shape causes the piston to push and rotate the cam, thereby closing the door.

### BRIEF DESCRIPTION OF THE DRAWINGS

The foregoing and other features and advantages of the present invention will be more clearly understood from the following detailed description and the accompanying drawings, in which,

FIG. 1 is an exploded perspective view of the preferred embodiment of the present invention in part;

FIG. 2 is an exploded perspective view of the preferred embodiment in part;

FIG. 3 is a sectional view of the preferred embodiment;

FIG. 4 is a schematic view of the preferred embodiment in a door closing operation; and

FIG. 5 is a schematic view of the preferred embodiment in a door opening operation.

### DETAILED DESCRIPTION OF THE PREFERRED EMBODIMENT

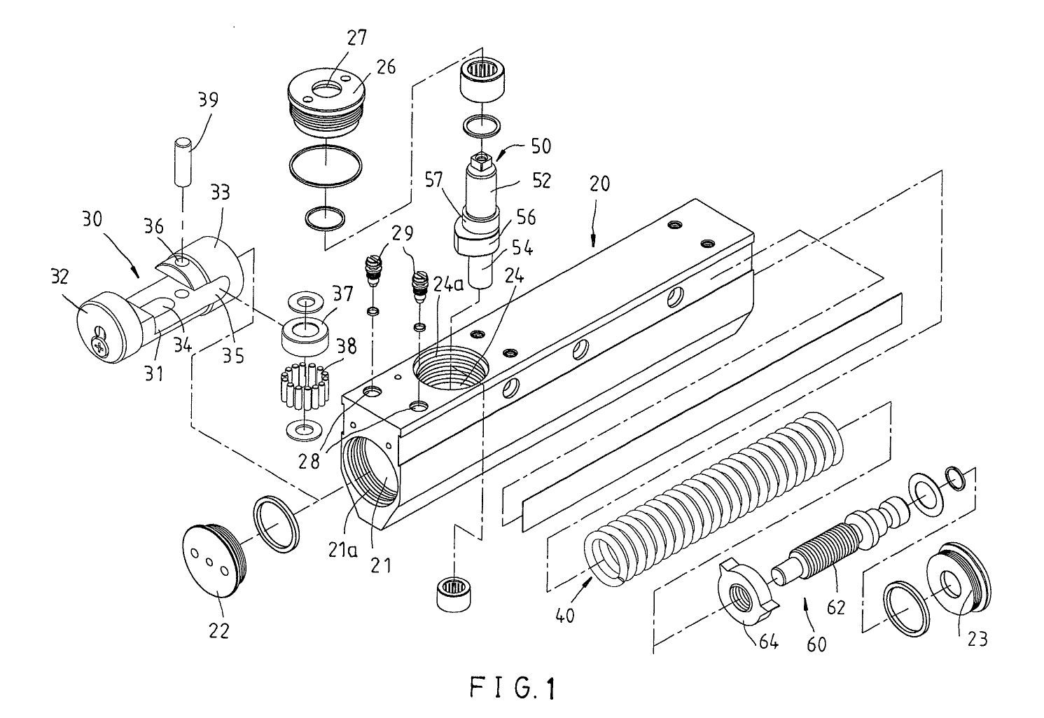

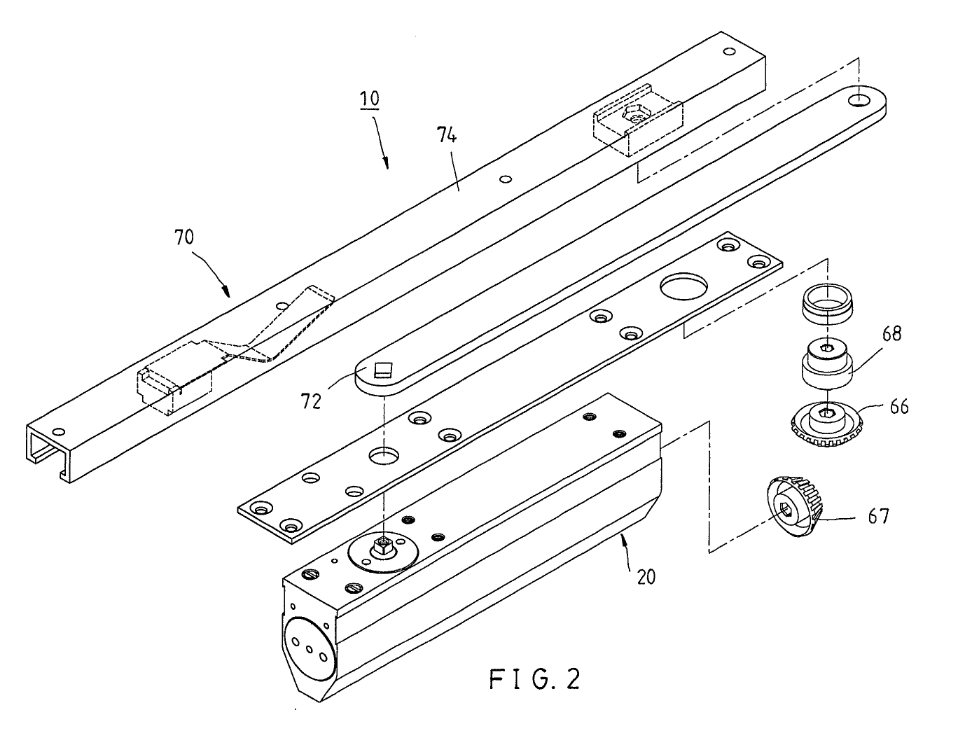

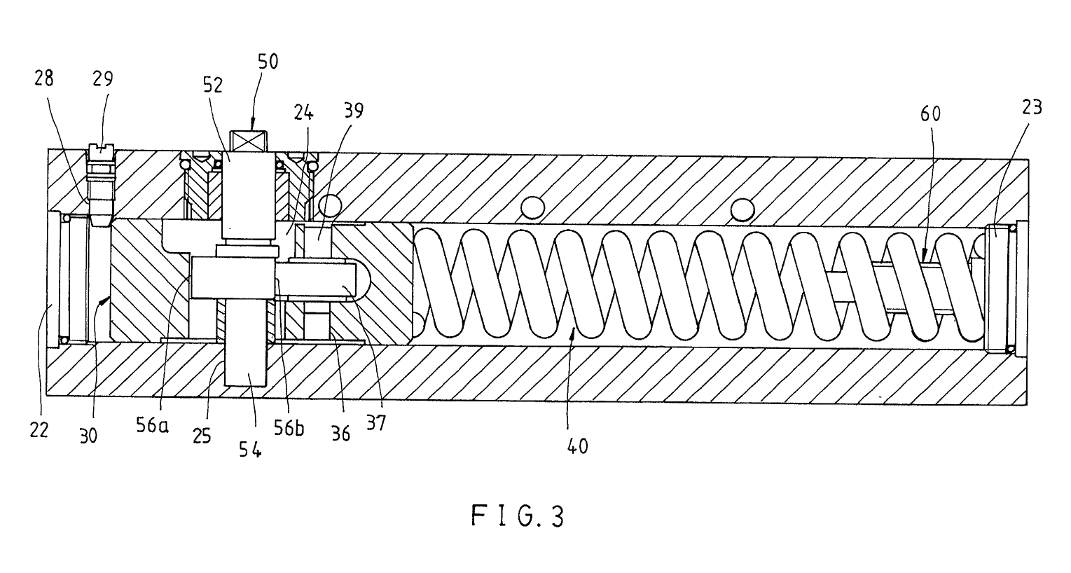

With reference to FIGS. 1 to 3, an improved door closer according to the preferred embodiment of the invention is designated by the reference numeral 10 and includes a base 20, a piston 30, a release member 40, a transmission shaft 50, an adjusting device 60 and a link member 70.

The base 20 is substantially rectangular and fixedly provided on the inner side of the door, and is provided with a transverse channel 21 in the long axis thereof. Both sides of the channel 21 are respectively provided with a female thread 21a for respectively threaded engagement with a sealing cover 22, 23 so that two ends of the channel 21 are in a closed state. One side of the channel 21 in the short axis of the base 20 is provided with a through hole 24 and a slot 25 corresponding to each other. The through hole 24 and the slot 25 are coaxial. The through hole 24 is provided with a female thread 24a for threaded engagement with a sleeve 26. The center of the sleeve 26 is provided with a through hole 27. The base 20 is provided with two hydraulic oil filling oils 28 adjacent to the through hole 24 and communicated with the channel 21, each of which is threadedly connected to a regulating valve 29 for oil pressure adjustment.

The piston 30 is slidably disposed in the channel 21 and has a connecting block 31 and left and right end blocks 32, 33 extending upward from two ends of the connecting block 31. The bottom portion of the connecting block 31 is provided with a guide groove 34 in the same direction as the long axis of the base 20. The right end block 33 is inwardly recessed to form an insert groove 35, and is provided with an axial hole 36 corresponding to upper and lower ends of the insert groove 35. A roller 37 is disposed in the insert groove 35. The inner periphery of the roller 37 is sequentially provided with a plurality of roller pins 38 that are radially spaced apart by a determined clearance. A securing pin 39 passes through the axial hole 36 and the roller 37 to be in a retained state.

The release member 40 is provided in the channel 21 to abut against the right end block 33 of the piston 30. In this invention, it is a spring to enable the piston 30 to reciprocate in the channel 21.

The transmission shaft 50 has first and second shaft portions 52, 54. A substantially heart-shaped cam 56 is provided on the second shaft portion 54 at the joint with the first shaft portion 52. A stop ring 57 is further provided on the first shaft portion 52 at the joint with the second shaft portion 54. The first shaft portion 52 passes through the through hole 27 in the sleeve 26. By means of the stop ring 57 of the first shaft portion 52, axial displacement of the transmission shaft 50 is prevented. The free end of the first shaft portion 52 projects from the base 20. The second shaft portion 54 is received in the guide groove 34 of the piston 30. The axial diameter thereof is equal to the width of the guide groove 34. The rear end thereof is pivotally disposed in the slot 25. The cam 56 has symmetrical left and right portions. The outer edge thereof has a first abutting end 56a and a second abutting end 56b respectively at the two ends in the direction of the largest axial length. The distance between the first abutting end 56a and the axis of the transmission shaft 50 is greater than the distance between the second abutting end 56b and the axis of the transmission shaft 50. The periphery of the first abutting end 56a further forms a projection 56c. The periphery of the second abutting end 56b forms a recess 56d. When the recess 56d of the cam 56 abuts against the roller 37, the release member 40 is in a free length state, and is compressed according to changes in curvature of profile of the cam 56 via rotation of the transmission shaft 50. When the first abutting end 56a abuts against the roller 37, the release member 40 is compressed to the largest extent.

The adjusting device 60 is provided in the channel 21 and includes an adjusting screw 62, an adjusting nut 64, upper and lower bevel gears 66, 67, and a force regulating seat 68. The adjusting screw 62 has one end passing through the sealing cover 23 to be engaged with the lower bevel gear 67, with the other end passing through the adjusting nut 64. The adjusting nut 64 abuts against the release member 40. The upper bevel gear 66 engages the lower bevel gear 67 with the top end thereof lockably disposed in the force adjusting seat 68. By means of rotating the force adjusting seat 68, the adjusting screw 62 can reciprocatingly retract a certain distance relative to the adjusting nut 64 so as to regulate tightness of the release member 40.

The link member 70 has a main arm 72 and a rotary arm 74 pivoted to the main arm 72. One end of the main arm 72 is fitted on the transmission shaft 50. One end of the rotary arm is pivoted on the upper edge of the door frame.

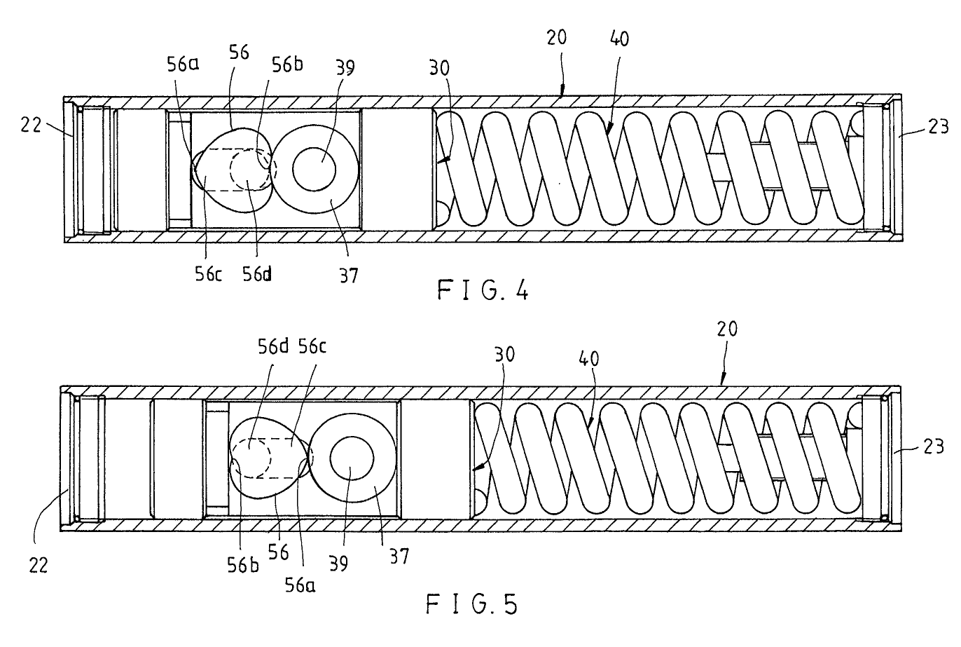

Referring to FIGS. 4 and 5, by virtue of the above construction, when the door closer 10 of the invention is in a stationary state when the door is closed, since the release member 40 is not compressed, the recess 56a of the cam 56 abuts against the roller 37. When the door is pushed open by an external force, the transmission shaft 50 is actuated thereby, and the profile of the cam 56 causes the release member 40 to be compressed. When the external force is removed, the release member 40 will resume its shape and pushes the cam 56 to thereby close the door.

During the door closing and opening operations, since the roller 38 of the piston 30 is kept in contact with the cam 56 any time, the operation thereof is smooth, which eliminates the drawback with the prior art in which, due to the existence of tooth clearance that results in intermediate contact between the gear and the rack, operation is not smooth. In addition, since the roller pins 38 radially provided on the inner periphery of the roller 37 are spaced apart by a determined clearance, when the projection 56c of the cam 56 abuts against the roller 37, there is a smaller friction so that the piston 30 can be smoothly pushed to achieve quick door closing. Further, since the securing pin 39 passes through the roller 37 and retained at the upper and lower ends of the roller 37, the roller 37 can be quite stable during rotation.

Furthermore, since the cam 56 has a symmetrical construction, during rotation of the cam 56, it is operable to the left or to the right so that the user can freely open the door from any one of the directions, thereby providing user facility.

In sum, the improved door closer of this invention improves the drawback of non-smooth operation associated with the prior art.

Although the present invention has been illustrated and described with reference to the preferred embodiment thereof, it should be understood that it is in no way limited to the details of such embodiment but is capable of numerous modifications within the scope of the appended claims.

What is claimed is:

1. An improved door closer, comprising:
a base which is axially provided with a transverse channel;
a piston slidable in said channel and having a connecting block and left and right end blocks extending upwardly from two ends of said connecting block, said connecting block having a bottom portion provided with a guide groove in the same direction as a long axis direction of said base, said right end block being recessed inwardly to form an insert groove, said right end block being provided with an axial hole relative to upper and lower ends of said insert groove, a roller being pivotally disposed in said insert groove;
a release member disposed in said channel to permit reciprocating movement of said piston therein;
a transmission shaft passing through said guide groove of said piston, an intermediate portion of said transmission shaft having a cam projecting therefrom to abut against said roller; and
a link member having one end connecting to a top end of said transmission shaft, with the other end pivoted at an upper edge of a door frame;
whereby when the door is pushed open by an external force, said cam rotates to cause said release member to be in a compressed state, and when the external force is released, a pushing force released by said release member when said release member resumes its original shape causes said piston to push and rotate said cam, thereby closing the door.

2. The improved door closer of claim 1, wherein said roller has an inner periphery radially provided with a plurality of roller pins, said roller pins being spaced apart from each other by a determined clearance so that when said cam abuts against said roller, there is a smaller friction.

3. The improved door closer of claim 1, wherein said piston further includes a securing pin, said securing pin passing through said roller via said axial hole to be retained at upper and lower ends of said roller.

4. The improved door closer of claim 1, wherein said cam is substantially heart-shaped and has a symmetrical left and right construction, an outer edge thereof being respectively provided with first and second abutting ends at two ends corresponding to a largest axial length direction of said transmission shaft, a distance between said first abutting end and axis of said transmission shaft being greater than a distance between said second abutting end and the axis of said transmission shaft.

5. The improved door closer of claim 1, wherein said release member is a spring.

6. The improved door closer of claim 1, further comprises an adjusting device disposed in said channel, said regulator including an adjusting screw and an adjusting nut, said adjusting screw having one end passing through said sealing cover, with the other end threadedly engaging said adjusting nut, said adjusting nut abutting against said release member, said adjusting screw being rotatable to adjust and control tightness of said release member.

7. The improved door closer of claim 6, wherein said adjusting device further includes upper and lower bevel gears and a force adjusting seat, said lower bevel gear being locked in said one end of said adjusting screw passing through said sealing cover, said upper bevel gear engaging said lower bevel gear and having an upper end lockably at said force adjusting seat, whereby said force adjusting seat is rotatable to cause said adjusting nut to reciprocatingly retract a determined distance relative to said adjusting nut so as to adjust and control tightness of said release member.
